(19) United States
(12) Patent Application Publication
(10) Pub. No.: US 2015/0258627 A1
(43) Pub. Date: Sep. 17, 2015

(54) LAYER COMPOSITE

(71) Applicant: KARLSRUHER INSTITUT FÜR TECHNOLOGIE (KIT), Karlsruhe (DE)

(72) Inventors: Prachai Norajitra, Karlsdorf-Neuthard (DE); Jarir Aktaa, Karlsruhe (DE); Luigi Spatafora, Karlsdorf-Neuthard (DE); Widodo Basuki, Karlsruhe (DE)

(21) Appl. No.: 14/435,454

(22) PCT Filed: Oct. 2, 2013
(86) PCT No.: PCT/EP2013/002964

§ 371 Date: Apr. 14, 2015

(30) Foreign Application Priority Data
Oct. 15, 2012 (DE) 10 2012 109 782.8

(51) Int. Cl. B23K 20/02; B32B 15/01

(52) U.S. Cl. CPC B23K 20/021; B32B 15/01

(57) ABSTRACT

A method for producing a layer composite includes providing a plurality of layers, each layer comprising a material comprising at least one of a metal, a metal alloy, and at least one layer comprising a metal which forms a solid solution with a refractory metal. Each layer of the plurality of layers is placed in an alternating manner one onto another so as to form a layer stack and so as to form contact surfaces. The plurality of layers in the layer stack are diffusion welded in a non-oxidizing atmosphere at a temperature of between 0.4 times and 0.9 times a melting temperature of the metal and at a pressure comprising a directional pressure component oriented orthogonally in relation to the contact surfaces. A magnitude of at least one of the pressure and the temperature change during the diffusion welding.

CROSS REFERENCE TO PRIOR APPLICATIONS

This application is a U.S. National Phase application under 35 U.S.C. §371 of International Application No. PCT/EP2013/002964, filed on Oct. 2, 2013 and which claims benefit to German Patent Application No. 10 2012 109 782.8, filed on Oct. 15, 2012. The International Application was published in German on Apr. 24, 2014 as WO 2014/060070 A1 under PCT Article 21(2).

### FIELD

The present invention relates to a method for producing a layer composite made of metals and/or of metal alloys comprising, for example, refractory metals, for example, in combination with tungsten and vanadium, or in combination with tungsten and titanium or tantalum. For this purpose, individual layers of the metals are layered one on another in an alternating manner and are integrally connected to one another by a uniaxial diffusion welding. The present invention also relates to a layer composite.

### BACKGROUND

Layer composite materials, also referred to as laminates, are composite materials, the material of which consists of two or more different bonded materials, e.g., metal-metal combinations, or metal-ceramic combinations, or metal-polymer combinations.

A composite material has different material properties to its individual components as a result of the production and the size of the composite material components.

“Refractory metals” in the present invention refer to the high-melting, base metals of the fourth transition group, titanium, zirconium and hafnium, of the fifth transition group, vanadium, niobium and tantalum, and of the sixth transition group, chromium, molybdenum, tungsten, ruthenium, rhenium, osmium, iridium, and to an alloy of the aforementioned metals.

Virtually all refractory metals exhibit a brittle-ductile transition of the material properties as a result of a body-centered cubic lattice structure. Refractory metals undergo brittle fracture at low temperatures and are ductile at high temperatures.

If, for example, molybdenum is heated above a certain temperature, it loses its brittleness and becomes ductile. The temperature required for the transition from brittleness to ductility is referred to as the “brittle-ductile transition temperature”.

The brittle-ductile transition temperature depends inter alia on the chemical composition and the degree of deformation of the semifinished product used, i.e., given the same chemical composition, the individual layers exhibit a different behavior when rolled or cast in the production process. Knowledge of the specific properties of this material group is essential when machining refractory metals. Non-cutting shaping, such as bending or chamfering, must be effected above the brittle-ductile transition temperature in order for the metal sheet to be reliably deformed without forming cracks. The thicker the metal sheet, the higher the temperatures required in order to shape it without the forming cracks.

It is possible to machine and also cut and punch refractory metals if the processing temperature has been set correctly.

The welding of refractory metals to one another using conventional welding methods (e.g., using TIG, an electron beam, a laser etc.) does not produce a sufficient integral bond even if the welding is performed under inert gas. This is caused by a high degree of coarse grain formation and the associated embrittlement of the weld seam. This also applies for welding refractory metals to steels.

The soldering of molybdenum to steel likewise affords only an operating temperature which is dependent on the melting temperature of the solder metal used, and therefore, a limited possibility for integral connections. Diffusion welding with a filler material, e.g., copper, also forms a brittle intermetallic phase which forms cracks during subsequent plastic deformation.

DE 4030 389 C1 describes a layer composite, a metal pipe with at least one foil made of a refractory metal, wherein a pipe shell of the metal pipe has a plurality of layers of foil made of refractory metal, and at least two layers of foil made of refractory metal are integrally connected to one another at least in certain regions. A tubular winding is thereby formed by the metal foils or metal layers, and at least the two innermost or the two outermost layers of the winding are then connected to one another in an explosive manner. This production method can only be used for thin laminates and does not represent a solution for laminates having 20 or more layers.

WO 2007/147792 A1 describes a method for producing shaped articles made of refractory metals, in particular, metal sheets made of tungsten or molybdenum, wherein a slip for foil casting is produced in powder form from a tungsten alloy or molybdenum alloy, a foil is cast from the slip, and the foil is freed of binder after drying and is sintered in order to obtain a metal sheet therefrom. This method does not, however, produce a layer composite within the context of the present invention.

The brittle material behavior of the refractory metals, particularly at low temperatures, such as e.g., in the case of tungsten, has to date prevented the use thereof as a structural material.

Laminates made of tungsten-vanadium are also brittle at room temperature and are therefore formable without the formation of cracks only above the brittle-ductile transition temperature.

The demands made on a structural component are a high ductility and a high fracture toughness, which is characterized by a high energy absorption in a notched bar impact bending test. The notched bar impact bending test is standardized according to DIN EN ISO 148-1 and 14556:2006-10.

### SUMMARY

An aspect of the present invention is to provide a method for an integral connection of a layer composite between refractory metals and/or refractory metal alloys in order to shift the brittle-ductile transition temperature toward lower temperatures, while at the same time obtaining a high strength, in particular, at high temperatures.

An additional aspect of the present invention is to provide a layer composite material as a structural component and/or as a functional component, so as to provide the advantageous material properties of different metals, for example, of refractory metals.

In an embodiment, the present invention provides a method for producing a layer composite which includes providing a plurality of layers, each layer comprising a material comprising at least one of a metal, a metal alloy, and at least one layer comprising a metal which forms a solid solution with a refractory metal. Each layer of the plurality of layers is placed in an alternating manner one onto another so as to form a layer stack and so as to form contact surfaces. The plurality of layers in the layer stack are diffusion welded in a non-oxidizing atmosphere at a temperature of between 0.4 times and 0.9 times a melting temperature of the metal and at a pressure comprising a directional pressure component oriented orthogonally in relation to the contact surfaces. A magnitude of at least one of the pressure and the temperature change during the diffusion welding. In an embodiment, the present invention also provides a layer composite which includes at least one layer comprising a refractory metal, and at least one layer comprising a metal which forms a solid solution with the refractory metal. The layers in each case lie on one another in an alternating manner. The layers are integrally connected to one another by a diffusion process so as to form a solid solution.

### BRIEF DESCRIPTION OF THE DRAWINGS

The present invention is described in greater detail below on the basis of embodiments and of the drawing in which:

FIG. 1 shows the chronological profile of a procedure with a variable pressure at a constant temperature.

### DETAILED DESCRIPTION

In an embodiment, the present invention provides a component made of refractory metal or a refractory metal alloy where the integral transition is produced by a uniaxial diffusion welding. The layer composite thereby has at least two layers made of different metals. At least two layers are thereby at least partially integrally connected to one another by means of uniaxial diffusion welding.

In an embodiment of the present invention, the layer composite can, for example, be entirely made up of individual layers, or is formed with solid parts of another material, a metal, in particular tungsten, vanadium, but also steel, aluminum or copper and/or a further refractory metal and one or more metal alloys. In this respect, metals can, for example, be used which, when combined with one another, form a solid solution rather than an intermetallic phase during the diffusion welding.

The layer composite in particular consists for the most part of refractory metals and/or refractory metal alloys and/or a plurality of layers made up of various parts made of a refractory metal, in particular, a plurality of layers made up of individual, i.e., separated, pieces made of a refractory metal. Layers made of various refractory metals can, for example, be used.

Use is in particular made of 2, 3, 4, 5, 6, 7, 8, 9, 10, 11, 12, 13, 14, 15, 16, 17, 18, 19, 20, etc. layers made of the same and/or at least partially different refractory metals or refractory metal alloys.

In order to achieve the best possible mechanical properties, the diffusion temperature must lie below the lowest recrystallization temperature of an involved material. These temperatures are usually between 0.4 times and 0.9 times the lowest melting temperature of an involved material.

Heat can be introduced by induction into the layer composite, and the introduction of heat can also vary cyclically in various stages or phases over the duration of the diffusion and also of the forming.

The required pressure can, for example, be applied to the layer composite by a punch, or without a punch by a fluid, for example, an inert gas such as e.g., helium, neon, argon, krypton, xenon, radon, or carbon dioxide (CO₂), nitrogen (N₂), or hydrogen (H₂).

Ideally smooth and completely clean surfaces do not in reality exist. All samples or semifinished products, no matter how well and precisely machined, always exhibit uneven and rough surfaces with a large number of roughness peaks. When two contact surfaces are placed one onto the other, the roughness peaks touch one another from both sides so that no continuous connection exists due to cavities being formed between the roughness peaks. The pressure, the temperature, the holding time, and also the surface roughness of the contact surfaces, which have, for example, an elliptical half-length of between 7 and 39 μm and a roughness depth of 0.8 to 3.5 μm, are of particular importance for the diffusion process.

In the unloaded state, in spite of the large number of roughness peaks which make contact with one another, the total contact surface area, depending on the roughness, amounts to only a small fraction of the entire surface area to be connected (Ag), e.g., between 0.00001 Ag up to 0.01 Ag. With such a small contact surface area, it is clear that it is not possible to produce a connection which has a strength which is approximately as high as that of the starting material. In this case, a connection of this nature is not referred to as welding, but rather as a bonding. For a diffusion connection, however, the connection must be present uniformly over the entire surface area so that a continuous connection is formed.

The atoms of both contact surfaces to be connected must be brought into the atomic bond (r0) spacing to produce a good connection. The decrease and increase in the atom spacing increases the potential energy thereof, and therefore the system leaves the stable equilibrium. In order to achieve the spacing r0, both halves of the sample must be pressed onto one another for a sufficiently long time under pressure with the direction of force being perpendicular to the connection surface. The roughness peaks which coincide thereby undergo such a severe local plastic deformation that an atomic spacing is locally achieved, and the interatomic forces of attraction start to act. This is, however, never achieved uniformly over the entire surfaces for a continuous connection without a noticeable plastic deformation of the entire sample body emerging.

In order to avoid this, the plastic deformation must interact with diffusion processes at a high temperature.

In order to provide a connection which is gentle on the material, the process temperature should be chosen so that no major changes which can negatively affect the mechanical properties of the entire layer composite (greatly reducing strength and ductility) takes place during the diffusion process in the materials to be connected (e.g., recrystallization, the temperature of which is influenced by the production history of the material). This temperature should not, however, be too low. The lower temperature limit lies at 0.4 times the melting temperature of the material with the lowest melting temperature. The transportation of material by diffusion processes is no longer significant below this limit. The lower temperature limit is approximately 590° C. for a tungsten-vanadium connection.

The pressure used in the diffusion process is in this case lower than or at most the same as the yield stress of the material at a given temperature so that no spontaneous plastic deformation of the entire layer composite arises. It is also necessary to consider the plastic deformation due to creep for a given diffusion duration. Through pressure exerted on the layer composite, it is necessary to provide that the surface roughness peaks of the individual layers of the layer composite undergo severe local plastic deformation. This provides that coinciding contact surfaces are increased in size and the remaining residual cavities become as small as possible so as to complete the diffusion processes in the shortest possible time.

The contact surfaces are normally contaminated with foreign particles or covered by layers of oil or oxide layers, etc. In order to achieve optimum diffusion results, the contact surfaces must first be cleaned. This is usually done by removing material from the surface by mechanical and chemical means (etching and pickling). The layers were introduced into an acetone bath immediately after etching in order to avoid the formation of surface oxide layers.

Despite the above pre-cleaning, continuous and brittle oxide layers can be found on the contact surfaces which are several atom layers thick. These oxide layers are broken up and dissected by the plastic deformation of the applied pressure. The contact surfaces thus freed of the oxide layer then connect better to one another, and the fragmented oxide layers are dissolved in the layer composite during the diffusion process. In this respect, it is advantageous to use a dynamic pressure profile during the diffusion process in order to further achieve local elastic and plastic micro-deformation. The dynamic pressure profile in a tungsten-vanadium connection process lies in the range of between 1 MPa and 500 MPa, in particularly between 10 MPa and 300 MPa. The duration of the diffusion process is not an independent parameter because it ultimately arises from the other predefined parameters. The duration should be kept as short as possible for physical and economic considerations at a given temperature and pressure. The duration must, however, be chosen to be long enough so that the diffusion processes required for forming a solid solution can proceed. An excessively long duration of the diffusion process can, in contrast, have the effect that individual brittle intermetallic phases form between the individual layers of the layer composite. In the case of tungsten-vanadium, the duration of the diffusion process and of the associated formation of a solid solution amounts to between several minutes and several hours.

In an embodiment of the present invention, a laser cutting method can, for example, be used to cut the individual layers of the layer composite since no additional plastic deformation and no burrs on the cut edges arise. The heat influencing region of the laser cutting method is also very small so that small surfaces of a layer can be produced.

It has already been found in tests that, by means of uniaxial diffusion welding without filler materials (such as e.g., soft solders S-Sn97Cu3, S-Sn97Ag3, or hard solders CP 203 (L-CuP6), CP 105 (L-Ag2)), a high-strength bond can surprisingly be produced between tungsten and vanadium, and the layer composite has a lower brittle-ductile transition temperature.

The present invention has already been successfully tested on a laboratory scale. In these tests, the tungsten and vanadium layers were cut by a laser cutting to between 50 and 200 μm, cleaned, e.g., with aqua regia and/or a solution of ammonia and sodium nitrate, the solution having a molar ratio of 1:1 to 1:1.5, then treated with acetone, layered one onto another in an alternating manner, and held in a vacuum furnace, with a not further herein described apparatus, at a temperature of 590-780° C., for example, 650-750° C., for example, 680-720° C., under a pressure of 50-300 MPa, for example, of 80-180 MPa, and with a cyclically repeating increase in the pressure of up to 300%, with a holding time of 2 to 20 hours, for example, of 3 to 10 hours. The duration of a cycle at elevated pressure is in a ratio of approximately 1/20 to 1/30 to the overall duration of the diffusion process.

It was possible to clearly demonstrate that the diffusion parameters and the preparation of the samples exert a particularly large influence on the quality and fatigue strength of the connection.

It has been found to be advantageous if the stresses which act perpendicular to the surfaces of the individual layers during the diffusion process vary in their maximum value and can range up to the yield strength. Stresses above the yield strength can also be achieved locally in this respect.

The layer composite was examined by metallographic methods. The strength of the connection was characterized by notched bar impact strength tests. On the basis of the results of these tests, diffusion parameters where identified which verify a very good durability and quality of the layer composite.

Parameters for the diffusion welding of refractory metals, in particular tungsten and vanadium, were, for example, determined empirically. In the context of an exemplary embodiment, these lie at a temperature of 700° C. and at a compressive stress of 100 MPa, with a holding time of approximately 4 h.

The present invention also provides a production method in order to form structural components made of the layer composite material described above into a near-net-shape geometry during the cooling phase and/or still during the diffusion phase.

In order to achieve a near-net-shape deformation of the layer stack and to make it possible to fully utilize the ductility of the materials involved, the forming process must take place at a temperature of between 0.4 and 0.8 times the melting temperature.

With the method according to the present invention, it is possible to produce structured workpieces made of refractory metals or refractory metal alloys which can be used, for example, as helium-cooled heat exchangers for a diverter in a fusion reactor, or for the effective dissipation of heat from and the cooling of electronic components.

Microstructured components produced by this method made of refractory metals or refractory metal alloys, in particular of tungsten or W-ODS (Oxide Dispersion Strengthened Tungsten), can be provided as parts for the construction of a gas heat exchanger with a thermal conductivity of approximately 100 W/mK.

Tungsten has a higher resistance in particular to thermal loading compared to aluminum or copper.

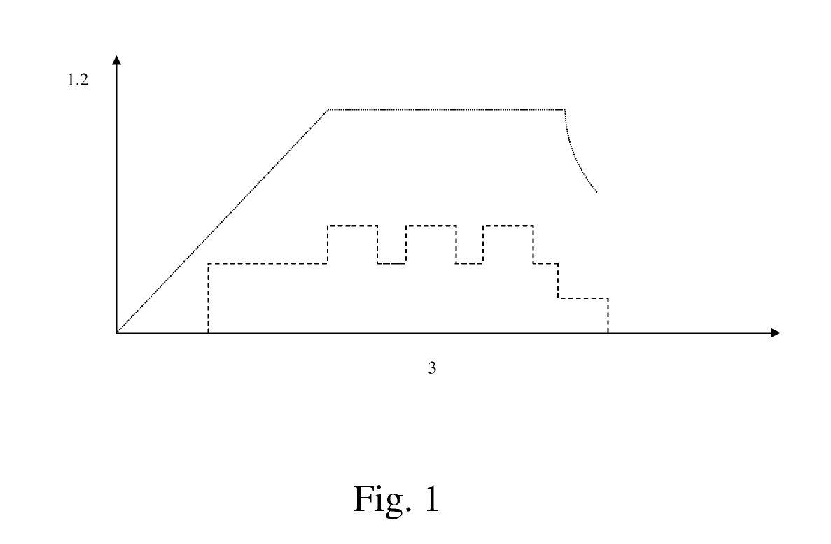

FIG. 1 shows the chronological profile of a procedure with a variable pressure at a constant temperature.

The present invention is not limited to embodiments described herein; reference should be had to the appended claims.

### LIST OF REFERENCE NUMERALS

1. T [° C.]

2. Pressure/stress [MPa]

3. Process duration [min]

What is claimed is:

1-8. (canceled)

9. A method for producing a layer composite, the method comprising:
providing a plurality of layers, each layer comprising a material comprising at least one of,
a metal,
a metal alloy, and
at least one layer comprising a metal which forms a solid solution with a refractory metal;
placing each layer of the plurality of layers in an alternating manner one onto another so as to form a layer stack and so as to form contact surfaces; and
diffusion welding the plurality of layers in the layer stack in a non-oxidizing atmosphere at a temperature of between 0.4 times and 0.9 times a melting temperature of the metal and at a pressure comprising a directional pressure component oriented orthogonally in relation to the contact surfaces,
wherein,
a magnitude of at least one of the pressure and the temperature change during the diffusion welding.

10. The method as recited in claim 9, wherein the pressure is introduced by a fluid.

11. The method as recited in claim 9, wherein the temperature is introduced into the layer stack by at least one of induction and conduction.

12. The method as recited in claim 9, wherein the pressure further comprises cyclically changing directional pressure components oriented at least one of orthogonally and parallel in relation to the contact surfaces.

13. The method as recited in claim 9, wherein the pressure is configured to fluctuate cyclically.

14. The method as recited in claim 9, wherein the pressure is configured to produce a local micro-stress above a yield strength in the layer composite of the respective material.

15. The method as recited in claim 9, wherein the method further comprises a cooling phase, the layer composite being plastically deformed during at least one of the diffusion welding and the cooling phase.

16. A layer composite comprising:
at least one layer comprising a refractory metal; and
at least one layer comprising a metal which forms a solid solution with the refractory metal,
wherein,
the layers in each case lie on one another in an alternating manner, and
the layers are integrally connected to one another by a diffusion process so as to form a solid solution.
